(19) United States
(12) Patent Application Publication
(10) Pub. No.: US 2019/0311033 A1
(43) Pub. Date: Oct. 10, 2019

(54) COMPUTER-IMPLEMENTED METHOD FOR RESOURCE MANAGEMENT IN A COMPUTER NETWORK

(71) Applicant: AI Exchange Ltd, London (GB)

(72) Inventor: Jos EVANS, London (GB)

(73) Assignee: AI Exchange Ltd, London (GB)

(21) Appl. No.: 15/947,405

(22) Filed: Apr. 6, 2018

(51) Int. Cl. G06F 17/27; G06Q 30/02; G06Q 10/06; G06F 9/50; H04L 12/58

(52) U.S. Cl. CPC G06F 17/2705; G06Q 30/0207; H04L 51/02; G06F 9/5005; G06Q 10/0631

(57) ABSTRACT

A computer-implemented method for use in a computer network is provided. The method comprises receiving, from a user device, a request associated with a resource; parsing the request from the user device; based on the parsing of the request from the user device, requesting, from each of a plurality of nodes in the computer network, a respective offer associated with the resource; receiving and parsing the respective offers; based on the parsing of the respective offers, determining a preferred offer; and sending the preferred offer to the user device.

### BACKGROUND

A chatbot (also known as a talkbot, chatterbot, bot, IM bot, interactive agent, or Artificial Conversational Entity) is a computer program which conducts a conversation via auditory or textual methods. Chatbots are often designed to convincingly simulate how a human would behave as a conversational partner. Chatbots can be used for many purposes.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 illustrates an exemplary system for implementing the methods described herein;

FIGS. 2a, 2b and 2c are three respective parts of a flowchart illustrating an example method described herein;

FIG. 3 is a flowchart illustrating an example method described herein; and

FIGS. 4a, 4b, 4c and 4d are four respective parts of a flowchart illustrating an example method described herein;

FIG. 5 is a block diagram of a computing device for implementing the example methods described herein.

### DETAILED DESCRIPTION

In the following Description, reference is made to the accompanying drawings, which form a part hereof, and in which is shown by way of illustration specific embodiments in which the invention may be practiced. It is to be understood that other embodiments may be utilized and structural or logical changes may be made without departing from the scope of the present invention. The following description, therefore, is not to be taken in a limiting sense. It is to be understood that features of the various example embodiments described herein may be combined, in part or whole, with each other, unless specifically noted otherwise.

The present disclosure relates generally to a computer-implemented method for resource management in a computer network and to a computer-implemented method for making resource-related recommendations.

An example computer-implemented method for use in a computer network includes receiving, from a user device, a request associated with a resource; parsing the request from the user device; based on the parsing of the request from the user device, requesting, from each of a plurality of nodes in the computer network, a respective offer associated with the resource; receiving and parsing the respective offers; based on the parsing of the respective offers, determining a preferred offer; and sending the preferred offer to the user device.

Optionally, the preferred offer corresponds to: one of the respective offers; or a plurality of the respective offers.

Optionally, each respective offer is from a corresponding one of the plurality of nodes, wherein the preferred offer corresponds to at least one of the respective offers from a corresponding at least one of the plurality of nodes, and wherein the method includes: receiving, from the user device, a message indicating acceptance of the preferred offer; sending, to each of the at least one of the plurality of nodes, a message indicating acceptance of the corresponding offer.

Optionally, the preferred offer corresponds to the plurality of the respective offers, wherein the includes: receiving, from the user device, an indication of a quantity of the resource requested; and determining that the quantity satisfies an excess quantity criterion, and wherein the preferred offer is determined in response to determining that the quantity satisfies the excess quantity criterion.

Optionally, the request associated with the resource is a request associated with a cost of the resource.

Optionally, the method includes: determining that a rejection condition for the preferred offer has been satisfied.

Optionally, determining that the rejection condition for the preferred offer has been satisfied comprises receiving, from the user device, a message indicating rejection of the preferred offer.

Optionally, the message indicating rejection of the preferred offer comprises a counteroffer.

Optionally, determining that the rejection condition for the preferred offer has been satisfied comprises determining that a timeout event has occurred.

Optionally, the method includes: in response to determining that the rejection condition for the preferred offer has been satisfied, requesting a counteroffer from the user device and/or at least one of the plurality of nodes.

Optionally, the method includes: retrieving data regarding a cost of the resource; wherein the user device and/or the at least one of the plurality of nodes from which the counteroffer is requested is selected based on the retrieved data regarding the cost of the resource.

Optionally, the user device is a first user device and the method includes: in response to determining that the rejection condition for the preferred offer has been satisfied, initiating a data communication between a second user device and the first user device, and/or at least one of the plurality of nodes.

Optionally, parsing the request from the user device inlcudes determining a type of the resource, the method includes: selecting the plurality of nodes in the computer network from which the respective offers are requested based on the type of the resource.

Optionally, the request from the user device and/or the respective offers are in natural language.

Optionally, the parsing includes: parsing the request from the user device using a plurality of natural language processing engines or parameter sets; determining a confidence level for the parsing of the request from the user device using each of the plurality of natural language processing engines or parameter sets; and based on the confidence levels, selecting a preferred natural language processing engine or parameter set from the plurality of natural language processing engines or parameter sets, wherein the requesting is based on the parsing using the preferred natural language processing engine or parameter set.

Optionally, the method includes: retrieving data relating to the resource; based on the retrieved data relating to the resource, sending a recommendation associated with the resource to the user device.

Optionally, the data relating to the resource is retrieved from a repository, the method inlcuding: storing, in the repository, data relating to the request and/or the respective offers.

Optionally, the method includes: determining whether the request from the user device conforms to at least one request validation criterion, wherein requesting the respective offers is conditional upon determining that the request from the user device conforms to the at least one request validation criterion.

Optionally, the method includes: determining whether each of the respective offers conform to at least one offer validation criterion, wherein the preferred offer corresponds to at least one of the respective offers that is determined to conform to the at least one offer validation criterion.

Optionally, the method includes: storing messages sent to, and received from, the user device and/or the plurality of nodes.

Optionally, communication with the user device and/or the plurality of nodes is via a communication layer arranged to interface with a third-party messaging service.

An example computer-implemented method including: receiving a natural language request associated with a resource from a user device; parsing the natural language request associated with the resource; based on the parsing, retrieving data regarding the resource; and based on the retrieved data, sending a recommendation associated with the resource to the user device.

Optionally, the data regarding the resource is retrieved from a plurality of sources.

Optionally, the method includes: based on the retrieved data, predicting a value associated with the resource, wherein the recommendation is based on the predicted value associated with the resource.

An example system includes: memory to store instructions; and a processing device to execute the instructions to: perform any of the methods described herein.

An example computer-readable medium inlcuding computer-readable instructions which, when executed by a processor, cause the processor to carry out any of the methods described herein.

In overview, a method of resource management in a computer network using a chatbot is provided. The method comprises receiving a request associated with a resource from a user device, parsing it, requesting offers associated with the resource from a plurality of nodes in a computer network, receiving and parsing the offers, determining a preferred offer, and sending it to the user device. If the offer is not accepted, the method may comprise requesting a counteroffer from the user device and/or the plurality of nodes.

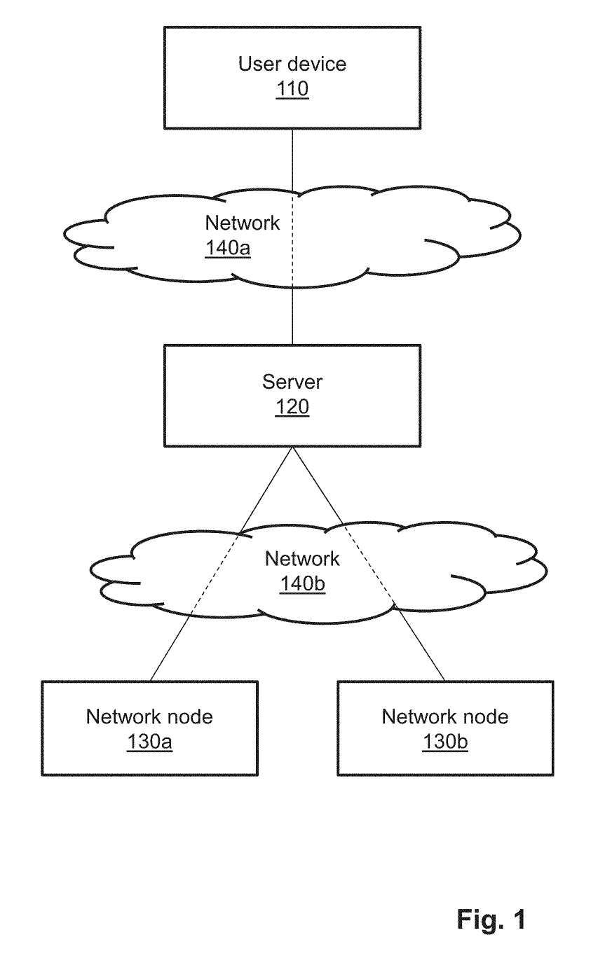

The methods described herein may be implemented by way of the system illustrated in FIG. 1. A user device (or ‘client’, or ‘client device’, or ‘requesting device’, or ‘initiator device’) 110 communicates with a server 120 via a first communications network 140a. The server (or ‘processing device’, or ‘botmaster’) 120 in turn communicates with first and second network nodes (or ‘nodes’, or ‘market maker devices’) 130a and 130b via a second communications network 140b to fulfil requests received from the user device 110. The first and second communications networks 140a and 140b may be a single network, e.g., the Internet.

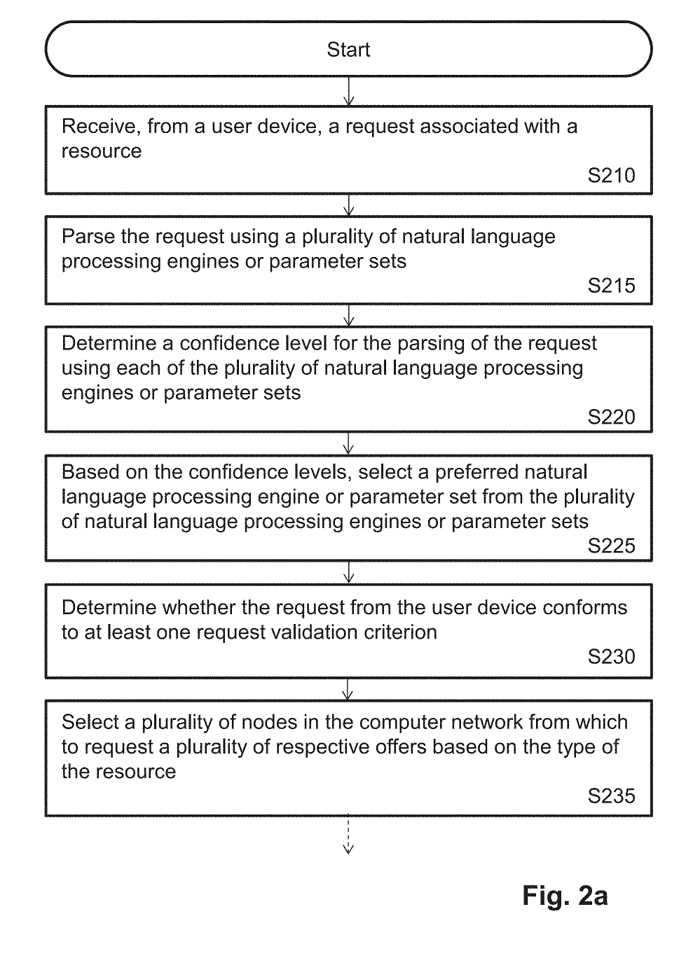

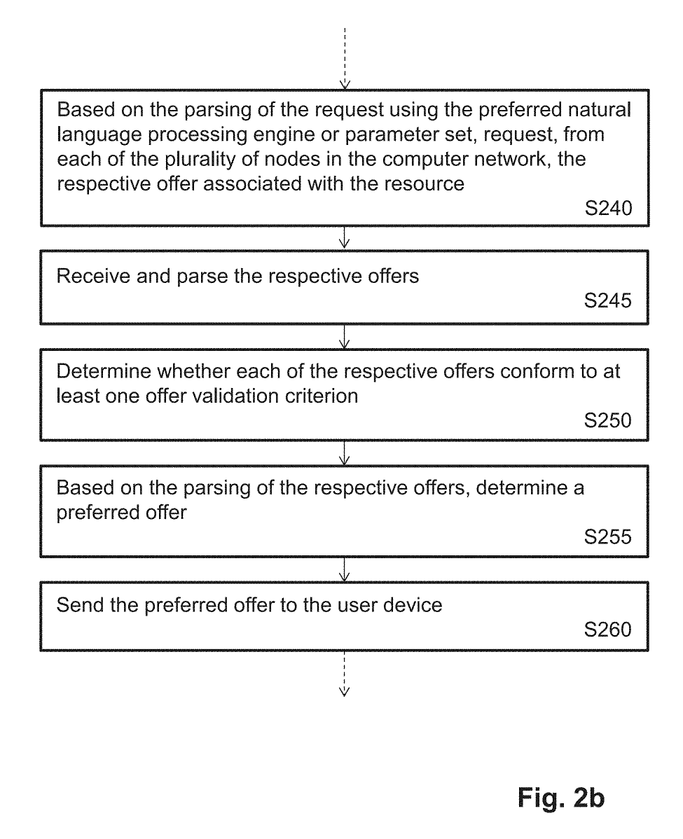

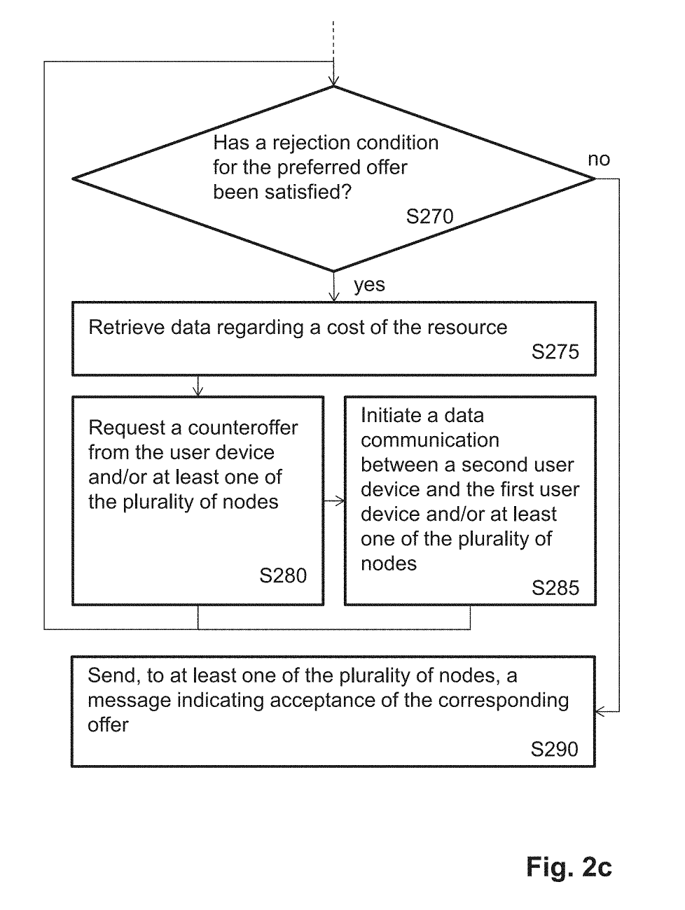

FIGS. 2a, 2b and 2c show three respective parts of a flowchart illustrating the steps of a computer-implemented method of resource management in a computer network. The method may be performed, for example, by the server 120.

At step S210, a request associated with a resource is received from the user device 110.

The request may be associated with a cost of the resource. It will be understood that, in the present disclosure, the ‘cost’ of a given resource may be any quantity representative of the resources required to obtain, produce or create the given resource, or indeed any quantity representative of a negative consequence of an event or decision. The cost need not, therefore, be a monetary cost. For example, a cost may be a computational cost or, in a routing context, a path cost.

The request is then parsed. Depending on the form of the request, the parsing may comprise extracting information from the request, and/or extracting meaning from the request.

If the request is in natural language, the request may be parsed using a natural language processing engine, which may, for example, be based on IBM's Watson system.

At step S215, the request is parsed using a plurality of natural language processing engines, or using a natural language processing engine with a plurality of natural language processing parameter sets.

It will be understood that the plurality of natural language processing parameter sets may be obtained by building a plurality of statistical models using a corresponding plurality of input data sets. Similarly, the plurality of natural language processing engines may be trained using a corresponding plurality of input data sets. The plurality of input data sets may correspond to a plurality of resource types. In this way, each parameter set or engine may be particularly suited to a request associated with a particular type of resource.

At step S220, a confidence level for the parsing of the request is determined using each of the plurality of natural language processing engines or parameter sets. The confidence level may be indicative of the likelihood that the request has been parsed or interpreted correctly.

At step S225, based on the confidence levels, a preferred natural language processing engine or parameter set is selected from the plurality of natural language processing engines or parameter sets. The preferred natural language processing engine or parameter set (more specifically, the output of the preferred natural language processing engine or the output of a natural language processing engine based on the preferred parameter set) is then used in the rest of the steps of the method, and in particular steps S235 and S240.

At step S230, it is determined whether the request conforms to at least one request validation criterion. The request may be considered, and subsequent steps (eg, step S240) performed, only if the request does conform to the at least one request validation criterion. The request validation criteria may ensure that the request is a plausible or realistic request.

At step S235, a plurality of nodes in the computer network from which to request a plurality of respective offers are selected based on the type of the resource. For example, for resources of a first type, offers may be requested from a first set of nodes, while for resources of a second type, offers may be requested from a second set of nodes. Alternatively, the respective offers may be requested from a plurality of predetermined nodes in the computer network, without taking into account the type of the resource.

At step S240, the respective offers are requested from each of the plurality of nodes in the computer network based on the parsing of the request. In the event that the request has been parsed using a plurality of natural language processing engines or parameter sets, the respective offers are requested based on the parsing of the request using the preferred natural language processing engine or parameter set. Requesting the respective offers may comprise sending an offer request message to each of the plurality of nodes.

At step S245, the respective offers are received and parsed. Each respective offer is from a corresponding one of the plurality of nodes 130 and 130b. The parsing may be similar to, or the same as, that of step S215. It will be understood that an offer may not be received from all of the nodes from which an offer has been requested.

At step S250, it is determined, for each respective offer, whether the respective offer conforms to at least one offer validation criterion. A respective offer may be considered only if the offer does conform to the at least one offer validation criterion. The offer validation criteria may ensure that a respective offer is plausible or realistic. The validation may take into account market data, eg, one of the criteria may be whether the offer is sufficiently close to a market value of the resource.

At step S255, based on the parsing of the respective offers, a preferred offer is determined. The preferred offer may correspond to one of the respective offers, or a plurality of the respective offers. The preferred offer may be determined based on only some of the respective offers that have been received, e.g., it may not be based on an offer that does not conform to the at least one offer validation criterion.

The user device may indicate a quantity of the resource requested, e.g., in the request or in a separate message. The preferred offer may be determined based on determining that the quantity satisfies an excess quantity criterion. For example, when the quantity exceeds a predetermined threshold, the predetermined offer may be determined so as to correspond to a plurality of respective offers, so as to reduce the resource quantity sought from each of the corresponding nodes.

At step S260, the preferred offer is sent to the user device. The preferred offer that is sent to the user device may not identify the node(s) to which it corresponds.

At step S270, it is determined whether a rejection condition for the preferred offer has been satisfied.

In one example, a rejection condition is determined to have been satisfied based upon receiving, from the user device 110, a message indicating rejection of the preferred offer. That message may, in one example, comprise a counteroffer.

In another example, a rejection condition is determined to have been satisfied based upon determining that a timeout event has occurred.

When a rejection condition is determined to have been satisfied, a number of steps (e.g., any of steps S275 to S285) may be taken to attempt to nevertheless have an offer accepted by the user device, in other words, to complete a transaction between the user device and at least one of the nodes.

At step S275, if a rejection condition has been satisfied, data regarding a cost of the resource is retrieved. The data may be retrieved from a third-party source.

At step S280, a counteroffer is requested from the user device and/or at least one of the plurality of nodes from which a respective offer was received. The purpose of the request for a counteroffer is to attempt to complete a transaction between the user device and at least one of the plurality of nodes despite the rejection condition having been satisfied.

The user device and/or the at least one node from which the counteroffer is requested may be selected based on the retrieved data regarding the cost of the resource. For example, if the retrieved data indicates that an offer from a node is close to the cost of the resource, a request for a counteroffer may be sent to the user device. Alternatively, if in rejecting the preferred offer the user device has made a counteroffer, and the counteroffer is close to the cost of the resource, a request for a counteroffer may be sent to the node(s) to which the preferred offer corresponds. In other words, the request for a counteroffer may be sent to the device/node having made an offer which is least close to the cost of the resource.

At step S285, a data communication is initiated between a second user device and the user device 110 from which the request was received and/or at least one of the plurality of nodes from which an offer was received. In this way, a user of the second user device may intervene in order to increase the likelihood of the user device 110 from which the request was received and at least one of the nodes coming to an agreement.

The method then returns to step S270, and steps S275-S285 may be repeated if the rejection condition remains satisfied.

A message indicating acceptance of the preferred offer, or a later counteroffer, may be received from the user device 110. As a result, the rejection condition may no longer be determined to be satisfied.

At step S290, if the rejection condition is not satisfied, or is no longer satisfied, a message is sent, the message indicating acceptance of at least one of the respective offers. For example, if the preferred offer corresponds to a set of respective offers from a corresponding set of nodes, the message indicating acceptance may be sent to each of the corresponding set of nodes. Alternatively, if the preferred offer corresponds to one respective offer from one corresponding node, the message indicating acceptance may be sent to that one corresponding node.

Steps S280 and S285 may operate as first and second levels of intervention in a stalled transaction. In other words, step S280 may first be performed and, if, the rejection condition remains satisfied, step S285 may then be performed.

In addition, in response to the request from the user device 110 in step S210, or another request from the user device 110, data relating to the resource may be retrieved and, based on that data, a recommendation associated with the resource may be sent to the user device 110. The data may be retrieved from a repository, in which data relating to the request and/or the respective offers is stored.

The request from the user device and/or the respective offers may be in natural language. In one example, the request from the user device is in natural language, but the respective offers are not.

Any of the messages sent to or from the server 120 may be stored or logged, e.g., for audit or compliance purposes. For example, messages sent to, and received from, the user device 110 may be stored. As another example, messages sent to, and received from, the first and second nodes 130a and 130b may be stored.

Communication with the user device and/or the plurality of nodes may be via a communication layer arranged to interface with a third-party messaging service, such as Skype®, Telegram®, Yahoo!® Messenger, or WhatsApp®.

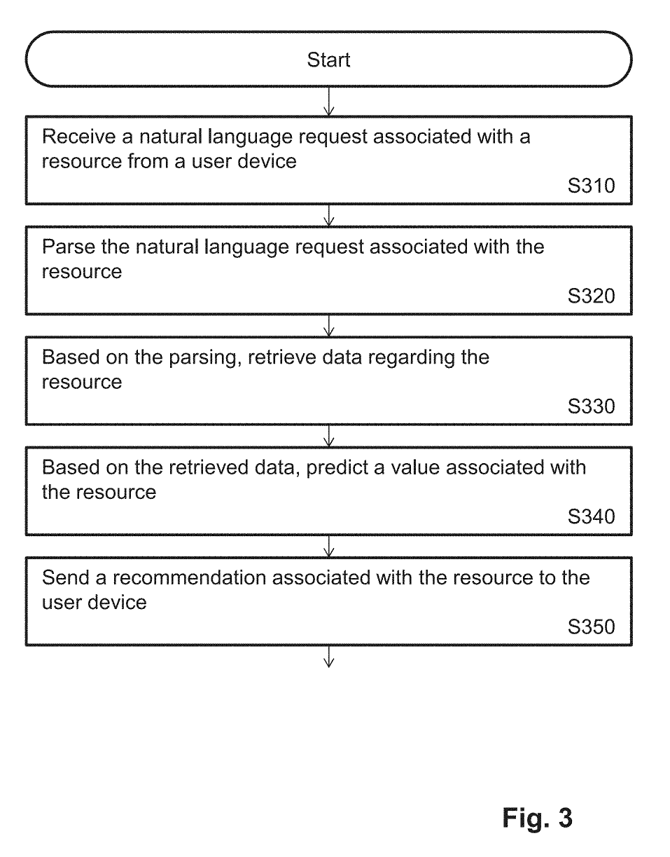

FIG. 3 shows a flowchart illustrating the steps of a computer-implemented method of making resource-related recommendations. The method may be implemented, for example, by the server 120.

At step S310, a natural language request associated with a resource is received from the user device. This request may be the same request as in step S210, or a different request.

At step S320, the request is parsed. The parsing may be the same as, or similar to, that of step S215.

At step S330, based on the parsing, data regarding the resource is retrieved. The data regarding the resource may be retrieved from a plurality of sources, and may then be aggregated.

At step S340, based on the retrieved data, a value associated with the resource is predicted.

At step S350, a recommendation associated with the resource is sent to the user device. The recommendation may be based on the predicted value associated with the resource.

The methods of FIGS. 2 and 3 are now illustrated with reference to a first example. In this example, the method is applied to the management of resources in a computing system distributed over a computer network; in other words, a distributed computing scenario.

In particular, the method comprises receiving, from a user device, such as a device controlling the operation of the computing system, a request for a computing resource or service, such as a compute service, a networking service, a database service, or a storage service.

The request is parsed and, based on the parsing, a plurality of nodes in the computer network are selected from which to request a plurality of respective offers. The selection is based on the type of the resource. For example, if the request is for a database service, then the request may be sent to the database servers in the computing network.

The respective offers from each of the plurality of nodes are requested, received and parsed. Based on the parsing, a preferred offer is determined. For example, the preferred offer may be the offer with the lowest cost. The cost of a given offer may represent the load on the node making the offer; for example, if a node already has a high load, then the cost may be high.

If the quantity of the resource requested exceeds a given threshold, the server may determine a preferred offer that corresponds to a plurality of the respective offers. In other words, the server may use a load balancing approach when determining the preferred offer.

The preferred offer is then sent to the user device. The user device can decide whether to accept the offer based, for example, on the cost of the preferred offer. For example, if the resource is needed for a task that has a low priority, then the user device may only accept an offer if the associated cost is relatively low.

An effect of the present disclosure is therefore to provide a more efficient resource management and allocation system in a computer network.

An effect of the present disclosure is also to efficiently manage and allocate capacity in a computer network.

An effect of the present disclosure is also to more quickly complete computing tasks by allocating them to nodes that are best placed to perform them.

The methods of FIGS. 2 and 3 are now illustrated with reference to a second example. In this example, the methods are applied to the trading of assets, such as currencies, securities, real estate, crops, or precious metals.

In this example, a request for the resource (step S210) may be an offer relating to an asset, such as an offer to buy and/or sell the asset.

The request may be parsed using a plurality of natural language processing engines or parameter sets (step S215), each suited to, or trained on, a particular class of assets. The natural language processing engine or parameter set to be used for processing the request can then be selected based on the confidence level of each of the natural language processing engines or parameter sets (steps S220-S225). The request may be validated by determining whether, for example, the request specifies a plausible desired price for the asset—if it does not, the request may not be processed.

The request is parsed and, based on the parsing, a plurality of nodes in the computer network are selected from which to request a plurality of respective offers (step S235). The selection is based on the type of the asset. For example, if the request is for a particular precious metal, offers may only be requested from nodes trading that particular precious metal. Offers may only be requested from nodes that are authorised to make offers for the particular type of asset, eg, for regulatory reasons. The selected nodes may be operated by market makers.

The respective offers from each of the plurality of nodes are requested, received and parsed (steps S240-S245). Based on the parsing, a preferred offer is determined. For example, the preferred offer may correspond to the offer with the lowest (or highest) cost. The preferred offer may correspond to a plurality of respective offers. For example, the preferred offer may correspond to a respective offer having the highest buy price and a respective offer having the lowest sell price. Each respective offer may be validated by determining whether, for example, the respective offer specifies a plausible price(s) for the asset—if it does not, the respective offer may not be processed and selected as a preferred offer.

If the quantity of the resource requested exceeds a given threshold, the server may determine a preferred offer that corresponds to a plurality of the respective offers. In other words, the server may split the transaction across multiple market makers. In this ‘iceberging’ approach, a large single order is divided into smaller orders, so as not to tip off the market.

The preferred offer is sent to the user device (step S260). If the user device sends a message to the server to accept the preferred offer, the server sends a message indicating the acceptance to each of the nodes to which the preferred offer corresponds (step S290), and the transaction is completed. Alternatively, the user device may send a message rejecting the preferred offer, optionally making a counteroffer for the resource, or the server may detect that a timeout event has occurred—the transaction between the user device and the server is then said to have ‘stalled’.

The server can request a counteroffer from the user device 110 and/or at least one of the plurality of nodes (step S280). The server can alternatively, or additionally, initiate a data communication between a second user device and the user device 110 and/or at least one of the plurality of nodes to which the preferred offer corresponds (step S285). In this way, a user of the second user device can seamlessly join a conversation with a user of the user device 110 or of any of the plurality of nodes to which the preferred offer corresponds. In this way, a stalled transaction can be moved forward.

The requesting of a counteroffer, or the initiating of a data communication, may be based on retrieved data regarding a cost of the resource (step S275), such as market data. In this way, the counteroffer can, for example, be requested from the party whose offer is furthest from the market rate/cost for the resource. Similarly, the user of the second user device can use the market data to advise the parties regarding their offers, thereby encouraging them to revise their offers.

Moving on to the steps of FIG. 3, a natural language request associated with a resource from a user device is received (step S310). The request may, for example, be for information regarding the resource. The request is parsed (step S320) and, based on the parsing, data regarding the resource is retrieved (step S330). The data may, for example, be market data. Based on the retrieved data, a value associated with the resource may be predicted (step S340). For example, a trend for the cost of the resource may be predicted (“Bitcoin is going up”). A recommendation associated with the resource is then sent to the user device (step S350). For example, the recommendation may be to buy or sell the resource (“Now would be a good time to buy Bitcoin”).

An effect of the present disclosure is to allow more efficient resource trading.

An effect of the present disclosure is to allow multiple offers from market makers to be requested simultaneously, rather than consecutively as a broker would, and for multiple offers to be received simultaneously. The present disclosure may therefore achieve results that are not achievable by a human.

An effect of the present disclosure is also to enable real-time monitoring of the pricing of assets.

An effect of the present disclosure is also to enable the user device to complete a transaction while communicating with only a single server, thereby providing a simpler trading system.

An effect of the present disclosure is also to enable a user to trade assets of different types via a single server.

An effect of the present disclosure is to provide a computer-implemented trading system that nevertheless allows for bargaining/negotiation.

An effect of the present disclosure is to allow a human operator to seamlessly join a chat that previously involved a chatbot.

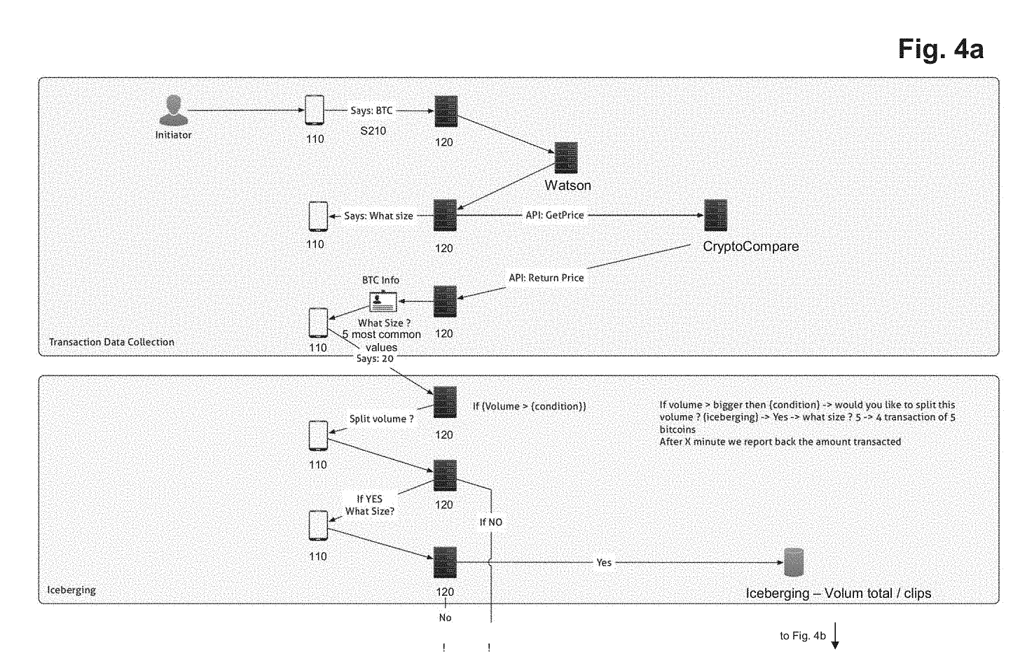

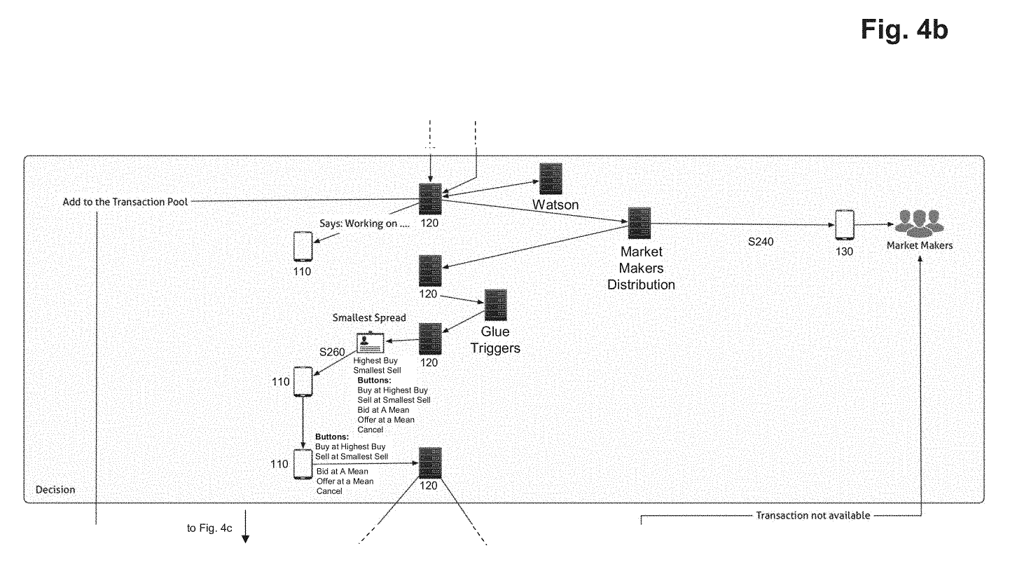

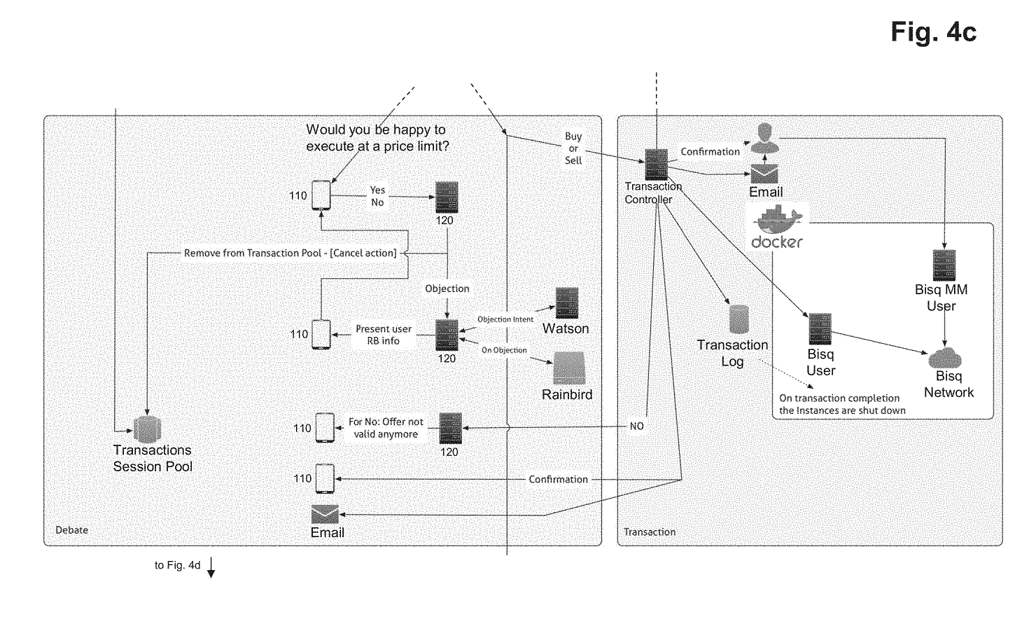

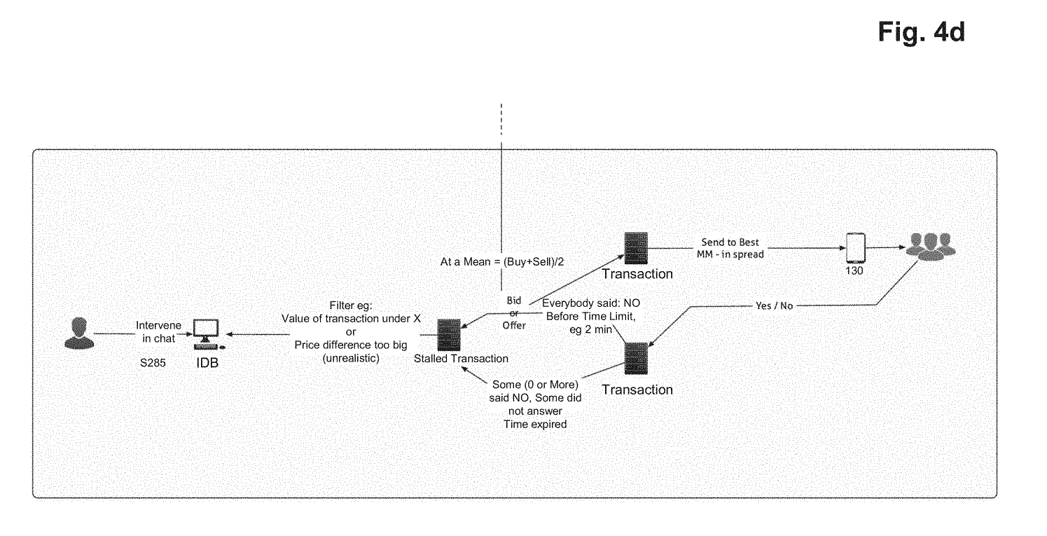

FIGS. 4a, 4b, 4c and 4d are four respective parts of a flowchart illustrating communications involved in the methods of FIGS. 2 and 3 in a trading scenario. In particular, in this scenario, Bitcoin (BTC) is the resource to be traded.

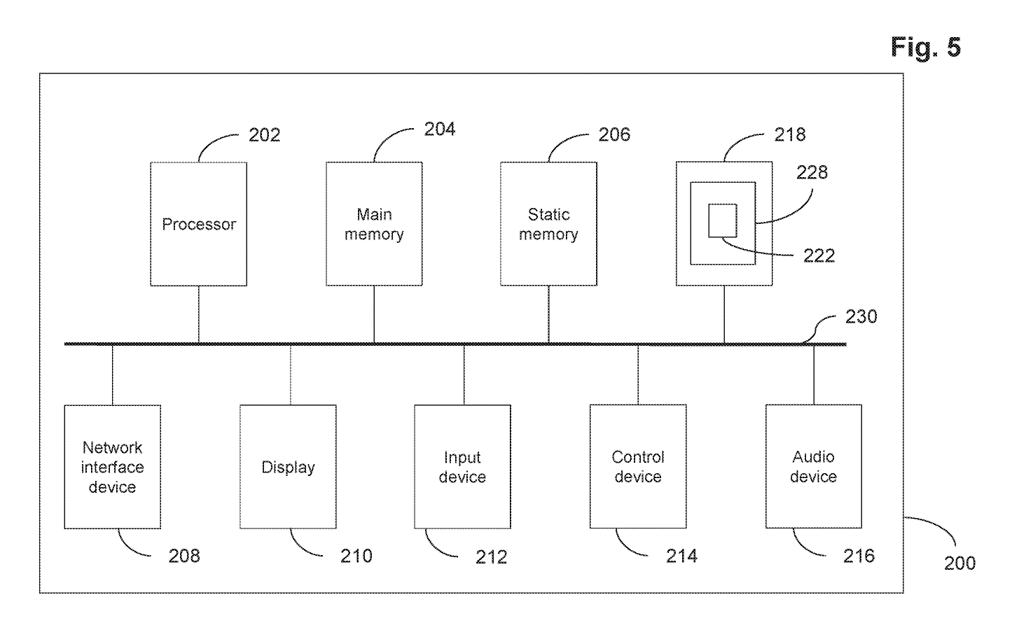

The functionality of any of the user device 110, the server 120, and/or the network nodes 130a and 130b may be provided by a computing/processing device. FIG. 5 illustrates a block diagram of one implementation of such a computing/processing device 200 within which a set of instructions, for causing the computing device to perform any one or more of the methodologies discussed herein, may be executed.

In some implementations, the computing device may be connected (e.g., networked) to other machines in a Local Area Network (LAN), an intranet, an extranet, or the Internet. The computing device may operate in the capacity of a server or a client machine in a client-server network environment, or as a peer machine in a peer-to-peer (or distributed) network environment. The computing device may be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single computing device is illustrated, the term “computing device” shall also be taken to include any collection of machines (e.g., computers) that individually or jointly execute a set (or multiple sets) of instructions to perform any one or more of the methodologies discussed herein.

The example computing device 200 includes a processing device 202, a main memory 204 (e.g., read-only memory (ROM), flash memory, dynamic random access memory (DRAM) such as synchronous DRAM (SDRAM) or Rambus DRAM (RDRAM), etc.), a static memory 206 (e.g., flash memory, static random access memory (SRAM), etc.), and a secondary memory (e.g., a data storage device 218), which communicate with each other via a bus 230.

Processing device 202 represents one or more general-purpose processors such as a microprocessor, central processing unit, or the like. More particularly, the processing device 202 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 202 may also be one or more special-purpose processing devices such as an application specific integrated circuit (ASIC), a field programmable gate array (FPGA), a digital signal processor (DSP), network processor, or the like. Processing device 202 is configured to execute the processing logic (instructions 222) for performing the operations and steps discussed herein.

The computing device 200 may further include a network interface device 208. The computing device 200 also may include a video display unit 210 (e.g., a liquid crystal display (LCD) or a cathode ray tube (CRT)), an alphanumeric input device 212 (e.g., a keyboard or touchscreen), a cursor control device 214 (e.g., a mouse or touchscreen), and an audio device 216 (e.g., a speaker).

The data storage device 218 may include one or more machine-readable storage media (or more specifically one or more non-transitory computer-readable storage media) 228 on which is stored one or more sets of instructions 222 embodying any one or more of the methodologies or functions described herein. The instructions 222 may also reside, completely or at least partially, within the main memory 204 and/or within the processing device 202 during execution thereof by the computer system 200, the main memory 204 and the processing device 202 also constituting computer-readable storage media.

The various methods described above may be implemented by a computer program. The computer program may include computer code arranged to instruct a computer to perform the functions of one or more of the various methods described above. The computer program and/or the code for performing such methods may be provided to an apparatus, such as a computer, on one or more computer-readable media or, more generally, a computer program product. The computer-readable media may be transitory or non-transitory. The one or more computer-readable media could be, for example, an electronic, magnetic, optical, electromagnetic, infrared, or semiconductor system, or a propagation medium for data transmission, for example for downloading the code over the Internet. Alternatively, the one or more computer-readable media could take the form of one or more physical computer-readable media such as semiconductor or solid state memory, magnetic tape, a removable computer diskette, a random access memory (RAM), a read-only memory (ROM), a rigid magnetic disc, and an optical disk, such as a CD-ROM, CD-R/W or DVD.

In an implementation, the modules, components and other features described herein can be implemented as discrete components or integrated in the functionality of hardware components such as ASICS, FPGAs, DSPs or similar devices.

A “hardware component” is a tangible (e.g., non-transitory) physical component (e.g., a set of one or more processors) capable of performing certain operations and may be configured or arranged in a certain physical manner. A hardware component may include dedicated circuitry or logic that is permanently configured to perform certain operations. A hardware component may be or include a special-purpose processor, such as a field programmable gate array (FPGA) or an ASIC. A hardware component may also include programmable logic or circuitry that is temporarily configured by software to perform certain operations.

Accordingly, the phrase “hardware component” should be understood to encompass a tangible entity that may be physically constructed, permanently configured (e.g., hardwired), or temporarily configured (e.g., programmed) to operate in a certain manner or to perform certain operations described herein.

In addition, the modules and components can be implemented as firmware or functional circuitry within hardware devices. Further, the modules and components can be implemented in any combination of hardware devices and software components, or only in software (e.g., code stored or otherwise embodied in a machine-readable medium or in a transmission medium).

It will be understood that the ordering of the steps in the methods of FIGS. 2a, 2b, 2c and 3 is merely exemplary, and that the steps could be performed in a different order. For example, step S230 may be performed after S235. The ordering of the steps of the methods described herein is particularly variable when human input is received from the users of the user device 110 and the plurality of nodes 130.

It will also be understood that the steps of FIGS. 2a, 2b, 2c and 3 need not all be performed and that, unless otherwise indicated, these steps are optional. For example, steps S230, S250, and S275 (inter alia) need not be performed. Furthermore, steps S215 to S225 need not be performed, and instead, the request may be parsed only once.

It will also be understood that the steps of FIGS. 2a to 2c and the steps of FIG. 3 may be combined, step S210 and S310 then optionally forming a single step.

Although the methods have been described in the context of two nodes 130a and 130b, it will be understood that these methods apply equally to scenarios where there are more than two nodes.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. A computer-implemented method for use in a computer network, the method comprising:
receiving, from a user device, a request associated with a resource;
parsing the request from the user device;
based on the parsing of the request from the user device, requesting, from each of a plurality of nodes in the computer network, a respective offer associated with the resource;
receiving and parsing the respective offers;
based on the parsing of the respective offers, determining a preferred offer; and
sending the preferred offer to the user device.

2. The method of claim 1, wherein the preferred offer corresponds to:
one of the respective offers; or
a plurality of the respective offers,
optionally wherein:
each respective offer is from a corresponding one of the plurality of nodes,
the preferred offer corresponds to at least one of the respective offers from a corresponding at least one of the plurality of nodes, and
the method further comprises:
receiving, from the user device, a message indicating acceptance of the preferred offer;
sending, to each of the at least one of the plurality of nodes, a message indicating acceptance of the corresponding offer.

3. The method of claim 2, wherein the preferred offer corresponds to the plurality of the respective offers,
wherein the method further comprises:
receiving, from the user device, an indication of a quantity of the resource
requested; and
determining that the quantity satisfies an excess quantity criterion, and
wherein the preferred offer is determined in response to determining that the quantity satisfies the excess quantity criterion.

4. The method of claim 1, wherein the request associated with the resource is a request associated with a cost of the resource.

5. The method of claim 1, comprising:
determining that a rejection condition for the preferred offer has been satisfied and, optionally,
in response to determining that the rejection condition for the preferred offer has been satisfied, requesting a counteroffer from the user device and/or at least one of the plurality of nodes and, further optionally,
retrieving data regarding a cost of the resource, wherein the user device and/or the at least one of the plurality of nodes from which the counteroffer is requested is selected based on the retrieved data regarding the cost of the resource.

6. The method of claim 5, wherein determining that the rejection condition for the preferred offer has been satisfied comprises receiving, from the user device, a message indicating rejection of the preferred offer, optionally wherein the message indicating rejection of the preferred offer comprises a counteroffer.

7. The method of claim 5, wherein determining that the rejection condition for the preferred offer has been satisfied comprises determining that a timeout event has occurred.

8. The method of claim 5, wherein the user device is a first user device and the method further comprises:
in response to determining that the rejection condition for the preferred offer has been satisfied, initiating a data communication between a second user device and:
the first user device, and/or
at least one of the plurality of nodes.

9. The method of claim 1, wherein parsing the request from the user device comprises determining a type of the resource, the method comprising:
selecting the plurality of nodes in the computer network from which the respective offers are requested based on the type of the resource.

10. The method of claim 1, wherein the request from the user device and/or the respective offers are in natural language.

11. The method of claim 1, wherein the parsing comprises:
parsing the request from the user device using a plurality of natural language processing engines or parameter sets;
determining a confidence level for the parsing of the request from the user device using each of the plurality of natural language processing engines or parameter sets;
based on the confidence levels, selecting a preferred natural language processing engine or parameter set from the plurality of natural language processing engines or parameter sets, and
wherein the requesting is based on the parsing using the preferred natural language processing engine or parameter set.

12. The method of claim 1, comprising:
retrieving data relating to the resource;
based on the retrieved data relating to the resource, sending a recommendation associated with the resource to the user device,
optionally wherein the data relating to the resource is retrieved from a repository and the method further comprises:
storing, in the repository, data relating to the request and/or the respective offers.

13. The method of claim 1, comprising:
determining whether the request from the user device conforms to at least one request validation criterion,
wherein requesting the respective offers is conditional upon determining that the request from the user device conforms to the at least one request validation criterion.

14. The method of claim 1, the method comprising:
determining whether each of the respective offers conform to at least one offer validation criterion,
wherein the preferred offer corresponds to at least one of the respective offers that is determined to conform to the at least one offer validation criterion.

15. The method of claim 1, comprising:
storing messages sent to, and received from, the user device and/or the plurality of nodes.

16. The method of claim 1, wherein communication with the user device and/or the plurality of nodes is via a communication layer arranged to interface with a third-party messaging service.

17. A computer-implemented method comprising:
receiving a natural language request associated with a resource from a user device;
parsing the natural language request associated with the resource;
based on the parsing, retrieving data regarding the resource; and
based on the retrieved data, sending a recommendation associated with the resource to the user device.

18. The method of claim 17, wherein the data regarding the resource is retrieved from a plurality of sources.

19. The method of claim 17, comprising:
based on the retrieved data, predicting a value associated with the resource,
wherein the recommendation is based on the predicted value associated with the resource.

20. A system, comprising:
memory to store instructions; and
a processing device to execute the instructions to:
receive a natural language request associated with a resource from a user device;
parse the natural language request associated with the resource;
based on the parsing, retrieve data regarding the resource; and
based on the retrieved data, send a recommendation associated with the resource to the user device.

21. A system, comprising:
memory to store instructions; and
a processing device to execute the instructions to:
receive, from a user device, a request associated with a resource;
parse the request from the user device;
based on the parsing of the request from the user device, request, from each of a plurality of nodes in the computer network, a respective offer associated with the resource;
receive and parse the respective offers;
based on the parsing of the respective offers, determine a preferred offer; and
send the preferred offer to the user device.
